(19) United States
(12) Patent Application Publication
(10) Pub. No.: US 2026/0061937 A1
(43) Pub. Date: Mar. 5, 2026

(54) TRUNK APPARATUS

(71) Applicants: Hyundai Motor Company, Seoul (KR); Kia Corporation, Seoul (KR)

(72) Inventors: Kyu Hoon Cho, Hwaseong-si (KR); Soo Bok Kim, Incheon (KR); Jung Hoon Park, Hwaseong-si (KR); Jae Seung Lee, Hwaseong-si (KR); Dae Hee Lee, Hwaseong-si (KR); Dong Wuk Choi, Hwaseong-si (KR); Won Ho Kim, Hwaseong-si (KR)

(21) Appl. No.: 19/078,606

(22) Filed: Mar. 13, 2025

(30) Foreign Application Priority Data
Aug. 29, 2024 (KR) 10-2024-0116973

(51) Int. Cl. B60R 5/04; B62D 35/00

(52) U.S. Cl. CPC B60R 5/041; B62D 35/007

(57) ABSTRACT

A trunk apparatus can include a spoiler cover configured to be tiltable at a rear end of a vehicle, and a trunk assembly located below the spoiler cover and configured to move vertically at the rear end of the vehicle. The trunk assembly is configured to move between a stowed position in which the trunk assembly is stowed in an interior space of the rear end of the vehicle and a deployed position in which the trunk assembly is deployed upward from the interior space of the rear end of the vehicle.

### CROSS-REFERENCE TO RELATED APPLICATIONS

This application is based on and claims the benefit of priority to Korean Patent Application No. 10-2024-0116973, filed on Aug. 29, 2024, in the Korean Intellectual Property Office, the disclosure of which is incorporated herein in its entirety by reference.

### TECHNICAL FIELD

The present disclosure relates to a trunk apparatus for a vehicle.

### BACKGROUND

A spoiler is an aerodynamic device whose intended design function to block or spoil unfavorable air movement across a body of a vehicle in motion to boost the performance of the vehicle.

Some vehicles such as high-performance vehicles and sports cars may include active spoilers satisfying all of the following features: driving stability, fuel efficiency, and seamless design. Meanwhile, due to the importance of seamless side profiles, convertible vehicles do not prefer spoiler types protruding to the outside of the body.

When the vehicle is driving at high speed, the active spoiler may be configured to be tiltable to generate downforce. When the vehicle is driving at low speed, the active spoiler may be configured to adjust wake flow to reduce air resistance. When the vehicle is stopped, the active spoiler may be stored in the rear of the vehicle body to enhance the aesthetics (exterior styling) of the vehicle body.

The convertible vehicle may include a tonneau cover configured to cover and protect a cabin (passenger compartment), and a vehicle body with a relatively short rear overhang. Because the rear overhang of the convertible vehicle is relatively short, a trunk space may be very narrowed at the rear of the convertible vehicle, and accordingly it may be difficult to apply the active spoiler and the trunk to the rear of the convertible vehicle at the same time. When the active spoiler is applied to the rear of the convertible vehicle, it may be difficult to open and close the trunk space and a lid. Even when the active spoiler is not applied to the rear of the convertible vehicle, the length of the trunk space may be very short and the depth of the trunk space may be relatively deep, making it harder for a user to use the trunk space.

The above information described in this background section is provided to assist in understanding the background of the present disclosure, and may include technical information that is not considered as the prior art that is already publicly known, available, or in use.

### SUMMARY

The present disclosure relates to a trunk apparatus for a vehicle, and more particularly, to a trunk apparatus designed to improve aerodynamics and secure a sufficient trunk space at a rear end of a vehicle with a relatively short rear overhang.

An embodiment of the present disclosure can solve the above-mentioned problems occurring in the prior art while advantages achieved by the prior art are maintained intact.

An embodiment of the present disclosure can provide a trunk apparatus designed to improve aerodynamics and secure a sufficient trunk space at a rear end of a vehicle with a relatively short rear overhang.

According to an embodiment of the present disclosure, a trunk apparatus may include: a spoiler cover configured to be tiltable at a rear end of a vehicle; and a trunk assembly located below the spoiler cover and configured to move vertically at the rear end of the vehicle.

The trunk assembly may be configured to move between a stowed position in which the trunk assembly is stowed in an interior space of the rear end of the vehicle and a deployed position in which the trunk assembly is deployed upward from the interior space of the rear end of the vehicle.

The trunk assembly may include a trunk box having a storage opening which is open to the rear of the vehicle, and a trunk cover attached to the top of the trunk box.

The trunk apparatus may further include a lift actuator configured to move the trunk assembly upward and downward.

The lift actuator may include a bed extending in a vertical direction of the vehicle, a lead screw rotatably mounted on the bed, a moving block movable in a longitudinal direction of the bed by the rotation of the lead screw, and a drive motor rotating the lead screw. The moving block may be connected to the trunk assembly.

The lift actuator may further include an upper support block fixed to a top end of the bed, and a lower support block fixed to a bottom end of the bed. A moving distance or moving range of the moving block may be restricted by the upper support block and the lower support block.

The trunk apparatus may further include a link mechanism configured to tiltably connect the spoiler cover to the trunk assembly.

The trunk apparatus may further include a tilt actuator configured to allow the spoiler cover to be tiltable with respect to the trunk assembly.

The tilt actuator may be mounted between the lift actuator and the spoiler cover.

The link mechanism and the tilt actuator may be connected to the spoiler cover by a hinge mechanism.

The tilt actuator may include a housing tube and a moving tube movably connected to the housing tube.

The housing tube may include a lower joint pivotally connected to the lift actuator, and the moving tube may include an upper joint pivotally connected to the spoiler cover.

The upper joint may be pivotally connected to the spoiler cover behind the link mechanism.

The trunk apparatus may further include a latch mechanism configured to lock and unlock the spoiler cover to and from the rear end of the vehicle.

The trunk apparatus may further include a seal enclosing the trunk box. The rear end of the vehicle may have an opening through which the trunk box extends, and the seal may be mounted on edges of the opening.

### BRIEF DESCRIPTION OF THE DRAWINGS

The above and other features and advantages of the present disclosure can be more apparent from the following detailed description taken in conjunction with the accompanying drawings, in which:

FIG. 1 illustrates a perspective view of a trunk apparatus according to an example embodiment of the present disclosure, which is mounted at a rear end of a vehicle;

FIG. 2 illustrates a perspective view of a trunk box of a trunk apparatus according to an example embodiment of the present disclosure, which is deployed upward from a rear end of a vehicle;

FIG. 3 illustrates a perspective view of a trunk apparatus according to an example embodiment of the present disclosure;

FIG. 4 illustrates a perspective view of a trunk assembly of a trunk apparatus according to an example embodiment of the present disclosure;

FIG. 5 illustrates a perspective view of a spoiler of a trunk apparatus according to an example embodiment of the present disclosure;

FIG. 6 illustrates an exploded perspective view of a trunk apparatus according to an example embodiment of the present disclosure;

FIG. 7 illustrates a lift actuator of a trunk apparatus according to an example embodiment of the present disclosure;

FIG. 8 illustrates a plan view of a trunk apparatus according to an example embodiment of the present disclosure, which is mounted at a rear end of a vehicle;

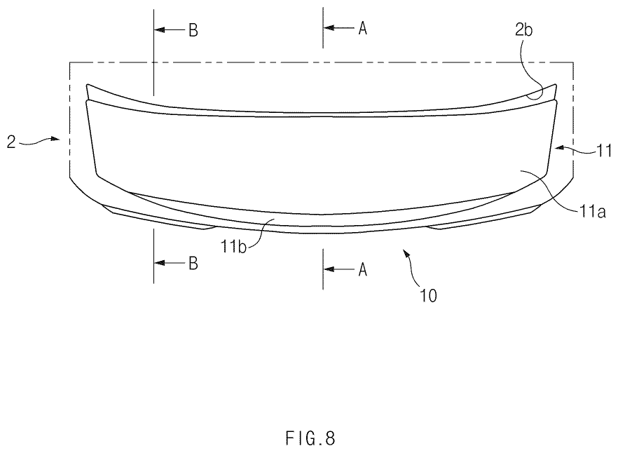

FIG. 9 illustrates a cross-sectional view, taken along line A-A of FIG. 8;

FIG. 10 illustrates a latch mechanism of a trunk apparatus according to an example embodiment of the present disclosure;

FIG. 11 illustrates a cross-sectional view, taken along line B-B of FIG. 8, in which a spoiler is in a horizontal position by a link mechanism and a tilt actuator in a trunk apparatus according to an example embodiment of the present disclosure;

FIG. 12 illustrates a state in which a spoiler is in a tilt position by a link mechanism and a tilt actuator in a trunk apparatus according to an example embodiment of the present disclosure;

FIG. 13 illustrates a state in which a link mechanism and a tilt actuator are connected to a spoiler through a hinge mechanism, and the spoiler is in a horizontal position by the link mechanism and the tilt actuator in a trunk apparatus according to an example embodiment of the present disclosure;

FIG. 14 illustrates a state in which a link mechanism and a tilt actuator are connected to a spoiler through a hinge mechanism, and the spoiler is in a tilt position by the link mechanism and the tilt actuator in a trunk apparatus according to another example embodiment of the present disclosure; and

FIG. 15 illustrates a perspective view of a trunk assembly, which is deployed upward from a rear end of a vehicle, with a spoiler in a maximum tilt position in a trunk apparatus according to an example embodiment of the present disclosure.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. A detailed description of well-known techniques associated with the present disclosure can be omitted to not unnecessarily obscure the gist of the present disclosure.

Terms such as “first,” “second,” “A,” “B,” “(a),” and “(b)” may be used to describe elements in example embodiments of the present disclosure. These terms can be used merely to distinguish one element from another element, and the intrinsic features, sequence or order, and the like of the corresponding elements are not necessarily limited by these terms. Unless otherwise defined, terms used herein, including technical or scientific terms, can have same meanings as those generally understood by those with ordinary knowledge in the field of art to which the present disclosure belongs. Such terms as those defined in a generally used dictionary can be interpreted as having meanings equal to the contextual meanings in the relevant field of art.

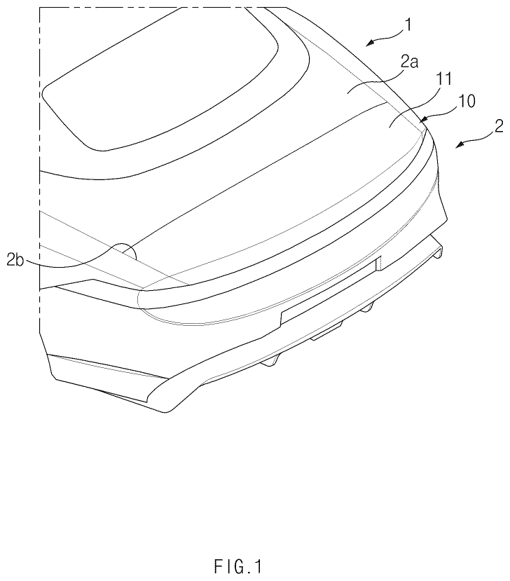

Referring to FIG. 1, a trunk apparatus 10 according to an example embodiment of the present disclosure may include a spoiler cover 11 disposed at a rear end 2 of a vehicle 1.

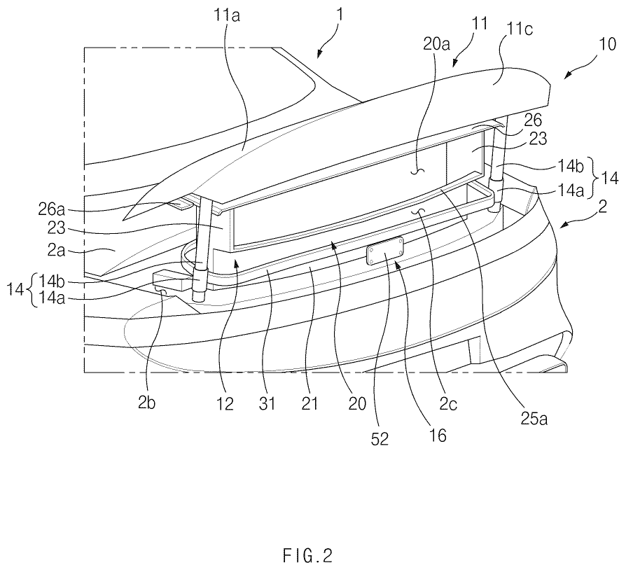

Referring to FIG. 2, the rear end 2 of the vehicle 1 may have a top surface 2a inclined toward the rear of the vehicle, an accommodating space 2b located behind the top surface 2a, and an opening 2c provided in the accommodating space 2b. The trunk apparatus 10 may be disposed in the accommodating space 2b, the spoiler cover 11 may be configured to be tiltable in the accommodating space 2b, and the trunk apparatus 10 may be located behind the top surface 2a of the rear end 2.

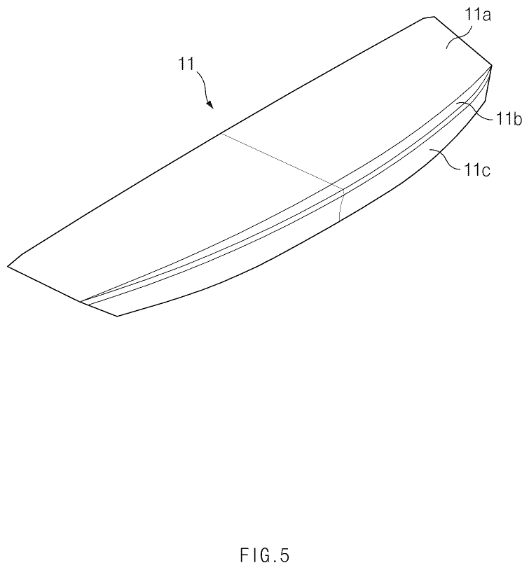

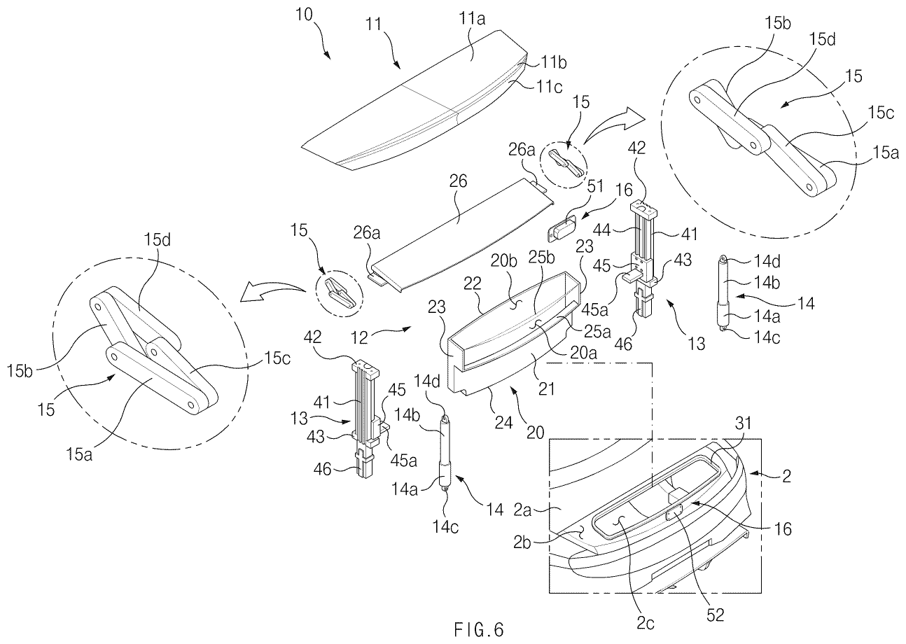

Referring to FIGS. 5 and 6, the spoiler cover 11 may include a first aerodynamic surface 11a, a second aerodynamic surface 11b connected to a rear edge of the first aerodynamic surface 11a, and an end surface 11c inclined downward from a rear edge of the second aerodynamic surface 11b toward the bottom of the vehicle. The first aerodynamic surface 11a may be inclined downward toward the rear of the vehicle, and an angle of inclination of the first aerodynamic surface 11a may correspond to an angle of inclination of the top surface 2a of the rear end 2. The second aerodynamic surface 11b may be inclined upward from the rear edge of the first aerodynamic surface 11a toward the rear of the vehicle.

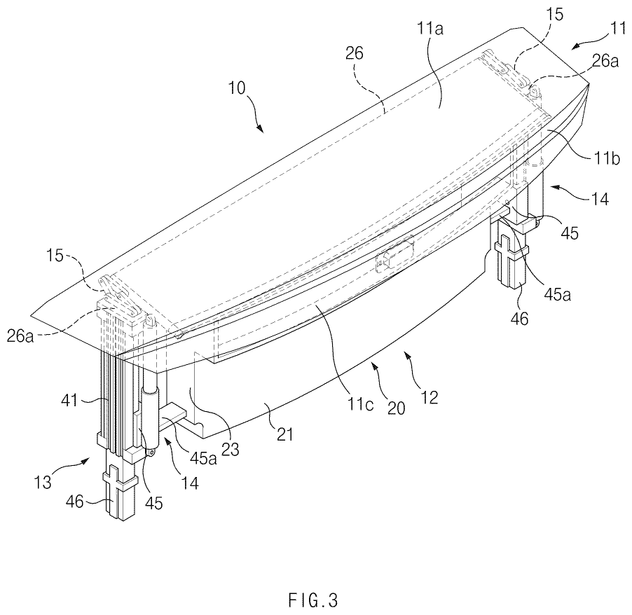

Referring to FIGS. 2 and 3, the trunk apparatus 10 according to an example embodiment of the present disclosure may include a trunk assembly 12 located under the spoiler cover 11.

The trunk assembly 12 may be configured to move vertically upward and downward at the rear end 2 of the vehicle 1. The trunk assembly 12 may include a trunk box 20 having a storage opening 20a which is open to the rear of the vehicle, and a trunk cover 26 attached to the top of the trunk box 20.

The trunk box 20 may be stowed in an interior space of the rear end 2 or be deployed upward from the interior space of the rear end 2 through the opening 2c. The trunk box 20 may have a storage space defined therein, and luggage may be loaded into and unloaded from the storage space of the trunk box 20. Referring to FIG. 6, the trunk box 20 may include a rear wall 21 facing the rear of the vehicle, a front wall 22 facing the front of the vehicle, a pair of sidewalls 23 facing both sides of the vehicle, a bottom wall 24 facing the bottom of the vehicle, a horizontal wall 25a extending horizontally from a top edge of the rear wall 21 toward the rear of the vehicle, and a connection wall 25b located above the horizontal wall 25a.

The horizontal wall 25a may connect middle portions of the pair of sidewalls 23 in a width direction of the vehicle, and the connection wall 25b may connect upper portions of the pair of sidewalls 23 in the width direction of the vehicle. The storage opening 20a may be defined by the horizontal wall 25a and the connection wall 25b, and a user may store luggage in the storage space of the trunk box 20 through the storage opening 20a.

The trunk box 20 may have a top opening 20b which is open to the top of the vehicle. As the trunk cover 26 is fixed to top edges of the trunk box 20, the trunk cover 26 may cover the top opening 20b.

The trunk apparatus 10 according to an example embodiment of the present disclosure may include a pair of lift actuators 13 configured to move the trunk assembly 12 upward and downward. Each lift actuator 13 may be connected to the corresponding sidewall 23 of the trunk box 20.

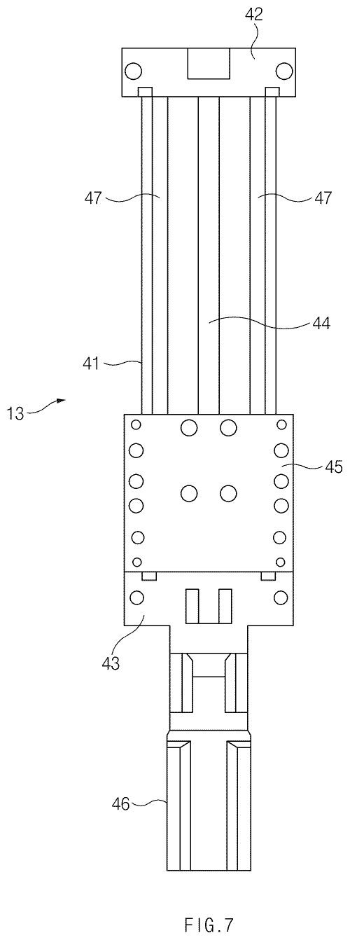

Referring to FIG. 7, each lift actuator 13 may include a bed 41 extending in a vertical direction of the vehicle, an upper support block 42 fixed to a top end of the bed 41, a lower support block 43 fixed to a bottom end of the bed 41, a lead screw 44 rotatably mounted on the bed 41, a moving block 45 movable in a longitudinal direction of the bed 41 by the rotation of the lead screw 44, and a drive motor 46 rotating the lead screw 44.

The upper support block 42 may be fixed to the rear end 2 of the vehicle 1, and the upper support block 42 may restrict an upward moving distance of the moving block 45. The lower support block 43 may be fixed to the rear end 2 of the vehicle 1, and the lower support block 43 may restrict a downward moving distance of the moving block 45. The lead screw 44 may extend in the longitudinal direction of the bed 41, and the lead screw 44 may be rotatably supported to the upper support block 42 and the lower support block 43 through a bearing and the like. The lead screw 44 may be configured to rotate around a central longitudinal axis thereof, and the lead screw 44 may have an external thread provided on an outer surface thereof.

The moving block 45 may have an internal thread meshing with the external thread of the lead screw 44. Accordingly, as the lead screw 44 is rotated by the drive motor 46, the moving block 45 may reciprocate along a longitudinal direction of the lead screw 44 and the longitudinal direction of the bed 41. For example, a lead nut (not shown) having an internal thread meshing with the external thread of the lead screw 44 may be fixed to the moving block 45 or be integrally formed with the moving block 45, and accordingly the moving block 45 may have the internal thread meshing with the external thread of the lead screw 44.

The moving block 45 may be connected to the trunk box 20 of the trunk assembly 12. For example, the moving block 45 may be fixed to the corresponding sidewall 23 of the trunk box 20 through a fixed portion 45a, and the fixed portion 45a may extend from the moving block 45 toward the sidewall 23 of the trunk box 20.

As the moving block 45 moves along the longitudinal direction of the lead screw 44, the trunk assembly 12 may reciprocate together with the moving block 45 in the vertical direction of the vehicle.

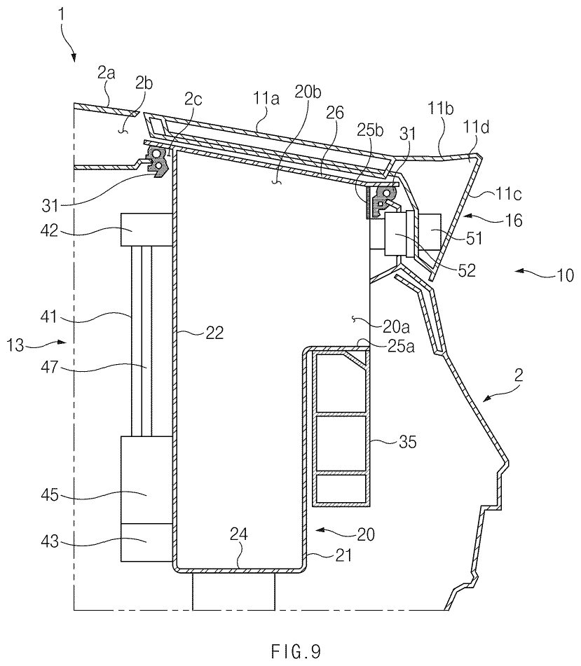

As the trunk assembly 12 moves upward and downward in the vertical direction of the vehicle by the pair of lift actuators 13, the trunk assembly 12 may be configured to move between a stowed position (see FIGS. 1 and 9) and a deployed position (see FIG. 2).

Referring to FIGS. 1 and 9, the stowed position refers to a position in which the trunk box 20 of the trunk assembly 12 is stowed in the interior space of the rear end 2 of the vehicle 1 to cover the storage opening 20a of the trunk box 20 as the trunk assembly 12 moves downward by the pair of lift actuators 13.

Referring to FIG. 2, the deployed position refers to a position in which the trunk box 20 of the trunk assembly 12 is deployed upward from the interior space of the rear end 2 of the vehicle 1 to allow the storage opening 20a of the trunk box 20 to be exposed to the outside of the vehicle as the trunk assembly 12 moves upward by the pair of lift actuators 13.

The trunk apparatus 10 may further include a seal 31 enclosing the trunk box 20, and the seal 31 may be mounted on edges of the opening 2c of the rear end 2. When the trunk assembly 12 is in the stowed position, the trunk cover 26 of the trunk assembly 12 may tightly contact the seal 31. Accordingly, even when the spoiler cover 11 is tilted with respect to the trunk cover 26, outside air, foreign objects, and the like may be prevented from entering the storage space of the trunk assembly 12 and/or the interior space of the rear end 2 of the vehicle 1.

The trunk apparatus 10 according to an example embodiment of the present disclosure may include a pair of link mechanisms 15 configured to tiltably connect the spoiler cover 11 to the trunk cover 26 of the trunk assembly 12.

The trunk cover 26 may include a pair of support lugs 26a provided on a pair of side edges thereof, respectively. Each support lug 26a may protrude outward from each side edge of the trunk cover 26.

The trunk cover 26 may be disposed below the spoiler cover 11, and the spoiler cover 11 may be connected to the support lugs 26a of the trunk cover 26 through the pair of link mechanisms 15. The spoiler cover 11 may be tiltably connected to the trunk cover 26 through the pair of link mechanisms 15.

Each link mechanism 15 may include a lower lever 15a connected to the trunk cover 26, an upper lever 15d connected to the spoiler cover 11, and a pair of lateral levers 15b and 15c pivotally connected to the lower lever 15a and the upper lever 15d. A lower end portion of a first lateral lever 15b may be pivotally connected to a first end portion of the lower lever 15a, and an upper end portion of the first lateral lever 15b may be pivotally connected to a first end portion of the upper lever 15d. A lower end portion of a second lateral lever 15c may be pivotally connected to a second end portion of the lower lever 15a, and an upper end portion of the second lateral lever 15c may be pivotally connected to a second end portion of the upper lever 15d.

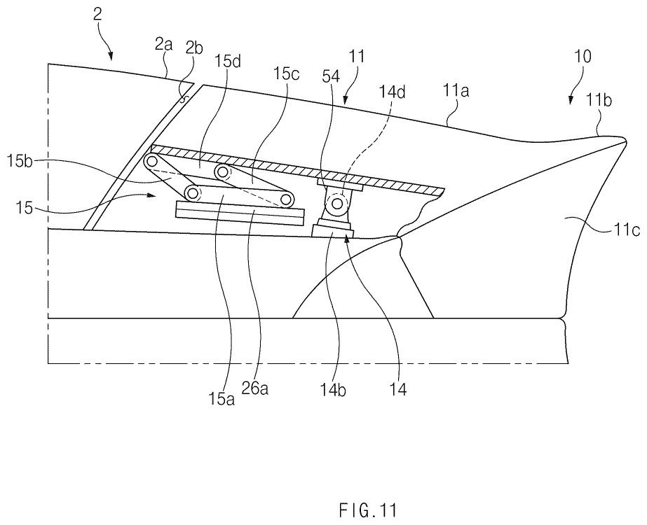

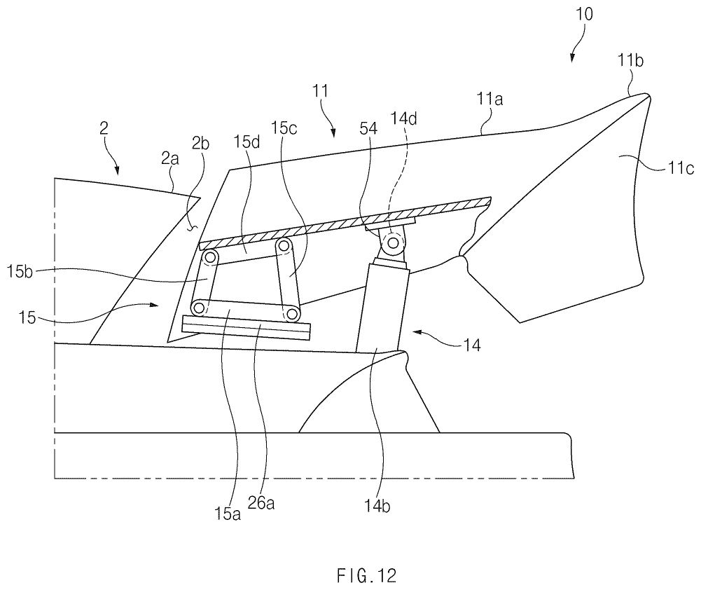

According to an example embodiment, as illustrated in FIGS. 11 and 12, the lower lever 15a may be fixed to the corresponding support lug 26a of the trunk cover 26, and the upper lever 15d may be fixed to the spoiler cover 11.

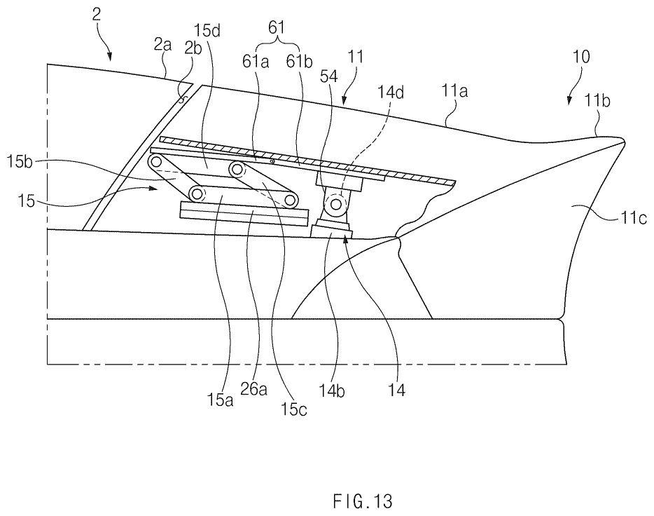

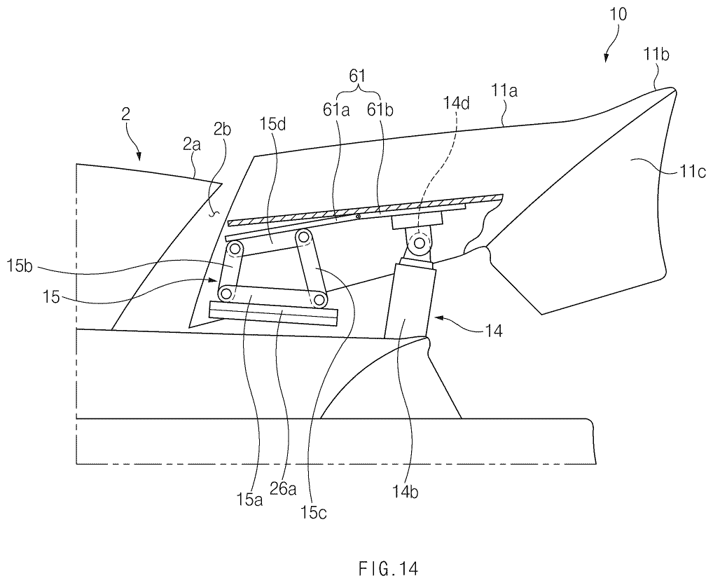

According to another example embodiment, as illustrated in FIGS. 13 and 14, the lower lever 15a may be fixed to the corresponding support lug 26a of the trunk cover 26, and the upper lever 15d may be connected to the spoiler cover 11 through a hinge mechanism 61.

The hinge mechanism 61 may be mounted on the spoiler cover 11. Referring to FIGS. 13 and 14, the hinge mechanism 61 may include a first hinge bracket 61a fixed to the upper lever 15d, and a second hinge bracket 61b pivotally connected to the first hinge bracket 61a. The first hinge bracket 61a may be fixed to the upper lever 15d of the link mechanism 15, and the second hinge bracket 61b may be fixed to a bottom surface of the spoiler cover 11. Accordingly, the upper lever 15d of the link mechanism 15 may be connected to the spoiler cover 11 through the hinge mechanism 61 whereby the accuracy and reliability of the tilting operation of the spoiler cover 11 may be improved.

The trunk apparatus 10 according to an example embodiment of the present disclosure may include a latch mechanism 16 configured to lock and unlock the spoiler cover 11 to and from the rear end 2 of the vehicle 1.

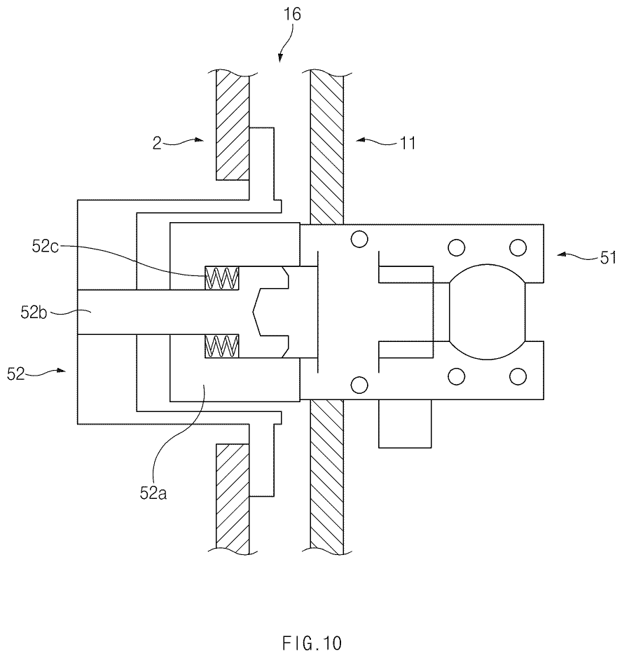

Referring to FIGS. 9 and 10, the latch mechanism 16 according to an example embodiment may include a magnetic module 51 and a contact module 52 provided between facing edges of the spoiler cover 11 and the rear end 2 of the vehicle 1. The magnetic module 51 may be configured to generate and block a magnetic field. As the magnetic module 51 generates the magnetic field, the contact module 52 may be attached to the magnetic module 51 by a magnetic force, and accordingly the magnetic module 51 may lock the contact module 52. As the magnetic module 51 blocks the magnetic field, the contact module 52 may not be attached to the magnetic module 51, and accordingly the magnetic module 51 may unlock the contact module 52. That is, the magnetic module 51 may be configured to lock and unlock the contact module 52 by the generation and blockage of the magnetic field, and the spoiler cover 11 may be locked to and unlocked from the rear edge of the rear end 2 of the vehicle 1 by the magnetic module 51 and the contact module 52.

Referring to FIG. 9, the magnetic module 51 may be provided at the rear edge of the spoiler cover 11, and the contact module 52 may be provided at the rear edge of the rear end 2 of the vehicle 1. According to an alternative example embodiment, the magnetic module 51 may be provided at the rear edge of the rear end 2 of the vehicle 1, and the contact module 52 may be provided at the rear edge of the spoiler cover 11.

According to an example embodiment, the magnetic module 51 may be a switchable magnetic device including a fixed magnet, a rotating magnet which is rotatable with respect to the fixed magnet, and an actuator which rotates the rotating magnet. According to an alternative example embodiment, the magnetic module 51 may be an electromagnet.

Referring to FIG. 10, the contact module 52 may include a contact plate 52a made of a magnetic material, and the contact plate 52a may be configured to be movable with respect to the magnetic module 51. The contact plate 52a may be configured to move between an attachment position in which the contact plate 52a is attached to the magnetic module 51 and a detachment position in which the contact plate 52a is detached and spaced apart from the magnetic module 51 by a predetermined gap. The contact module 52 may further include a guide pin 52b configured to guide the movement of the contact plate 52a. The contact plate 52a may be configured to move along the guide pin 52b. The contact module 52 may further include a biasing member 52c allowing the contact plate 52a to be biased so that the contact plate 52a may be spaced apart from the magnetic module 51 by a predetermined gap. The biasing member 52c may be a coil spring or leaf spring provided around the guide pin 52b. When the magnetic module 51 blocks the magnetic field, the contact plate 52a may be biased by the biasing member 52c to be spaced apart from the magnetic module 51 by a predetermined gap. As the magnetic module 51 is turned on, the magnetic module 51 may generate the magnetic field, and the contact plate 52a of the contact module 52 may be attached to the magnetic module 51 by the magnetic force, and accordingly the spoiler cover 11 may be locked to the rear end 2 of the vehicle 1. As the magnetic module 51 is turned off, the magnetic module 51 may block the magnetic field, and the contact module 52 may not be attached to the magnetic module 51, and accordingly the spoiler cover 11 may be unlocked from the rear end 2 of the vehicle 1.

According to another example embodiment, the latch mechanism may include a cinching latch and a striker provided between the facing edges of the spoiler cover 11 and the rear end 2 of the vehicle 1.

When the trunk assembly 12 is stowed in the interior space of the rear end 2 of the vehicle 1, the trunk assembly 12 may be held in the stowed position by a frictional force between the moving block 45 and the lead screw 44 of the lift actuator 13.

According to an alternative example embodiment, the bottom wall 24 of the trunk box 20 of the trunk assembly 12 or the moving block 45 may be locked to or unlocked from the bottom of the rear end 2 of the vehicle 1 by an auxiliary latch mechanism. Accordingly, the trunk assembly 12 may be stably held in the stowed position by the locking operation of the auxiliary latch mechanism.

The trunk apparatus 10 according to an example embodiment of the present disclosure may include a pair of tilt actuators 14 configured to allow the spoiler cover 11 to be tiltable with respect to the trunk cover 26 of the trunk assembly 12.

Each tilt actuator 14 may be mounted between the corresponding lift actuator 13 and the spoiler cover 11.

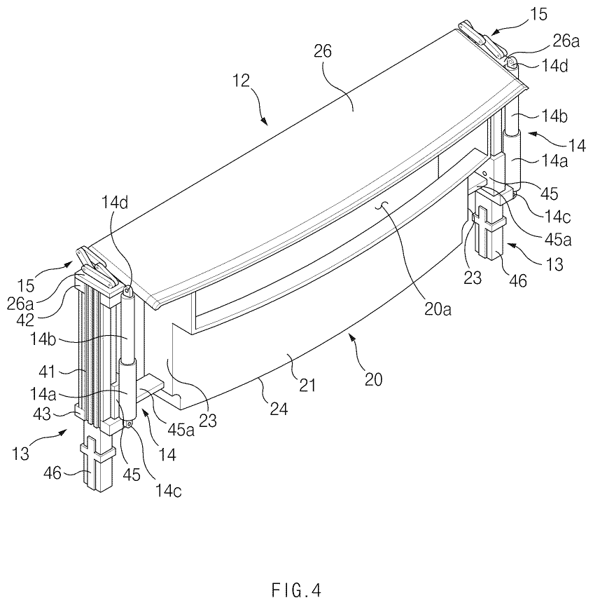

According to an example embodiment, the tilt actuator 14 may be a spindle drive configured to be extended and retracted. Referring to FIGS. 4 and 6, the tilt actuator 14 may include a housing tube 14a and a moving tube 14b movably connected to the housing tube 14a. For example, the tilt actuator 14 may include a motor disposed in the housing tube 14a, a spindle rotating by the motor, a spindle nut meshing with the spindle, and a spindle tube connected to the spindle nut. The spindle may have an external thread formed on an outer peripheral surface thereof, and the spindle nut may have an internal thread formed on an inner peripheral surface thereof. The external thread of the spindle may mesh with the internal thread of the spindle nut.

The housing tube 14a may be pivotally connected to the moving block 45 of the lift actuator 13. Specifically, the housing tube 14a may include a lower joint 14c provided on a bottom end thereof, and the lower joint 14c of the housing tube 14a may be pivotally connected to the moving block 45 of the lift actuator 13. The housing tube 14a may move together with the moving block 45 of the lift actuator 13 in the vertical direction of the vehicle.

The moving tube 14b may be pivotally connected to the spoiler cover 11. Specifically, the moving tube 14b may include an upper joint 14d provided on a top end thereof, and the upper joint 14d of the moving tube 14b may be pivotally connected to the spoiler cover 11.

The upper joint 14d of the moving tube 14b may be connected to the spoiler cover 11 behind the link mechanism 15.

Referring to FIGS. 11 and 12, an opposite joint 54 may be mounted on the spoiler cover 11 behind the upper lever 15d of the link mechanism 15, and the upper joint 14d of the moving tube 14b may be pivotally connected to the opposite joint 54 so that the upper joint 14d of the moving tube 14b may be pivotally connected to the spoiler cover 11.

Referring to FIGS. 13 and 14, the opposite joint 54 may be fixed to the second hinge bracket 61b of the hinge mechanism 61, and the upper joint 14d of the moving tube 14b may be pivotally connected to the opposite joint 54 so that the upper joint 14d of the moving tube 14b may be pivotally connected to the spoiler cover 11. Accordingly, the tilt actuator 14 may be connected to the spoiler cover 11 through the hinge mechanism 61 so that the force of the tilt actuator 14 may be more accurately transmitted to the spoiler cover 11.

When the spoiler cover 11 is unlocked from the rear end 2 of the vehicle 1 by the unlocking of the latch mechanism 16, and the trunk assembly 12 is in the stowed position or the deployed position, the spoiler cover 11 may be configured to move between a horizontal position (see FIGS. 11 and 13) and a tilt position (see FIGS. 12 and 14) by the tilt actuators 14 and the link mechanisms 15.

Referring to FIGS. 11 and 13, as the moving tube 14b moves back into the housing tube 14a, the tilt actuator 14 may be retracted. As the tilt actuator 14 is retracted, the spoiler cover 11 may move to the horizontal position along the movement path of the link mechanism 15. The horizontal position refers to a position in which the spoiler cover 11 is substantially parallel to a longitudinal axis of the vehicle.

Referring to FIGS. 12 and 14, as the moving tube 14b moves out of the housing tube 14a, the tilt actuator 14 may be extended. As the tilt actuator 14 is extended, the spoiler cover 11 may move to the tilt position along the movement path of the link mechanism 15. The tilt position refers to a position in which the spoiler cover 11 is inclined upward with respect to the longitudinal axis of the vehicle at various angles.

The spoiler cover 11 may be spaced apart from the rear end 2 of the vehicle 1 by a predetermined gap, and the spoiler cover 11 may be stably tilted with respect to the rear end 2 of the vehicle 1 and the trunk cover 26 of the trunk assembly 12.

In a state in which the trunk assembly 12 is in the stowed position, the tilt actuator 14 may be configured to operate in relation to the speed of the vehicle to secure driving stability of the vehicle and improve the downforce. That is, the extended length of the moving tube 14b of the tilt actuator 14 may be varied depending on the speed of the vehicle, and accordingly the tilt position (tilt angle) of the spoiler cover 11 may be varied. For example, as the speed of the vehicle increases, the extended length of the moving tube 14b of the tilt actuator 14 may be relatively increased, and accordingly the tilt angle of the spoiler cover 11 may be relatively increased. As the speed of the vehicle decreases, the extended length of the moving tube 14b of the tilt actuator 14 may be relatively reduced, and accordingly the tilt angle of the spoiler cover 11 may be relatively reduced. When the speed of the vehicle is lower than a predetermined speed or the vehicle is stopped, the moving tube 14b of the tilt actuator 14 may be fully retracted so that the spoiler cover 11 may be in the horizontal position, and accordingly the spoiler cover 11 may fully cover the accommodating space 2b of the rear end 2.

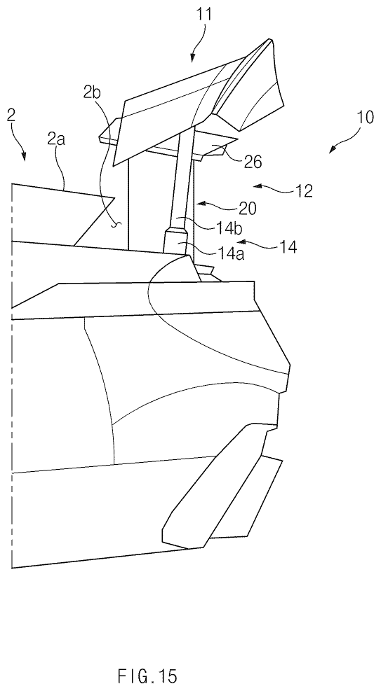

The spoiler cover 11 may be unlocked from the rear end 2 of the vehicle 1 by the unlocking of the latch mechanism 16, and the moving block 45 of the lift actuator 13 may move upward so that the trunk assembly 12 may move to the deployed position. Referring to FIG. 15, in a state in which the trunk assembly 12 is in the deployed position, the spoiler cover 11 may move to a maximum tilt position by the tilt actuators 14 and the link mechanisms 15. Accordingly, the storage opening 20a of the trunk assembly 12 may be fully exposed to the outside of the vehicle 1, and the user may easily load the luggage into the storage space of the trunk box 20 of the trunk assembly 12 or unload the luggage from the storage space of the trunk box 20.

According to the above-described example embodiments of the present disclosure, the spoiler cover 11 may be configured to tilt at the rear end 2 of the vehicle 1, thereby improving aerodynamics. As the trunk assembly 12 located below the spoiler cover 11 moves upward and downward at the rear end 2 of the vehicle 1, it may be easy for the user to load and unload the luggage into and from the trunk box 20 even if the depth of the trunk box 20 is relatively deep.

As set forth above, the trunk apparatus according to example embodiments of the present disclosure may be designed to improve aerodynamics by allowing the spoiler cover to be tiltable at the rear end of the vehicle. The trunk assembly located below the spoiler cover may be configured to move upward and downward at the rear end of the vehicle so that the loading and unloading of the luggage may be facilitated even if the depth of the trunk box is relatively deep.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims.

What is claimed is:

1. A trunk apparatus, comprising:
a spoiler cover configured to be tiltable at a rear end of a vehicle; and
a trunk assembly located below the spoiler cover and configured to move vertically at the rear end of the vehicle.

2. The trunk apparatus according to claim 1, wherein the trunk assembly is configured to move between a stowed position in which the trunk assembly is stowed in an interior space of the rear end of the vehicle and a deployed position in which the trunk assembly is deployed upward from the interior space of the rear end of the vehicle.

3. The trunk apparatus according to claim 1, wherein the trunk assembly includes a trunk box having a storage opening that is open to a rear of the vehicle, and a trunk cover attached to a top of the trunk box.

4. The trunk apparatus according to claim 1, further comprising a lift actuator configured to move the trunk assembly upward and downward.

5. The trunk apparatus according to claim 4, wherein the lift actuator comprises:
a bed extending in a vertical direction of the vehicle;
a lead screw rotatably mounted on the bed;
a moving block movable in a longitudinal direction of the bed by the rotation of the lead screw, wherein the moving block is connected to the trunk assembly; and
a drive motor configured to rotate the lead screw.

6. The trunk apparatus according to claim 5, wherein the lift actuator further comprises:
an upper support block fixed to a top end of the bed; and
a lower support block fixed to a bottom end of the bed, wherein a moving range of the moving block is restricted by the upper support block and the lower support block.

7. The trunk apparatus according to claim 4, further comprising a link mechanism configured to tiltably connect the spoiler cover to the trunk assembly.

8. The trunk apparatus according to claim 7, further comprising a tilt actuator configured to allow the spoiler cover to be tiltable with respect to the trunk assembly.

9. The trunk apparatus according to claim 8, wherein the tilt actuator is mounted between the lift actuator and the spoiler cover.

10. The trunk apparatus according to claim 9, wherein the link mechanism and the tilt actuator are connected to the spoiler cover by a hinge mechanism.

11. The trunk apparatus according to claim 9, wherein the tilt actuator includes a housing tube and a moving tube movably connected to the housing tube.

12. The trunk apparatus according to claim 11, wherein the housing tube includes a lower joint pivotally connected to the lift actuator, and
wherein the moving tube includes an upper joint pivotally connected to the spoiler cover.

13. The trunk apparatus according to claim 12, wherein the upper joint is pivotally connected to the spoiler cover behind the link mechanism.

14. The trunk apparatus according to claim 1, further comprising a latch mechanism configured to lock and unlock the spoiler cover to and from the rear end of the vehicle.

15. The trunk apparatus according to claim 3, further comprising a seal enclosing the trunk box,
wherein the rear end of the vehicle has an opening through which the trunk box extends, and wherein
the seal is mounted on edges of the opening.

16. A trunk apparatus for a vehicle, the trunk apparatus comprising:
a movable trunk assembly disposed at a rear end of the vehicle, the movable trunk assembly comprising:
a trunk box having a rear-facing opening, and
a lift actuator configured to move the movable trunk assembly upward and downward between a stowed position and a deployed position, such that the trunk box is accessible via the rear-facing opening in the deployed position and such that the trunk box is stowed in an interior space of the vehicle in the stowed position; and
a tiltable rear spoiler movably coupled to the movable trunk assembly, wherein at least part of the tiltable rear spoiler is located above the trunk box, and wherein the tiltable rear spoiler is configured to tilt relative to the movable trunk assembly.

17. The trunk apparatus according to claim 16, wherein the lift actuator comprises:
a bed extending in a vertical direction of the vehicle;
a lead screw rotatably mounted on the bed;
a moving block movable in a longitudinal direction of the bed by the rotation of the lead screw; and
a drive motor configured to rotate the lead screw, wherein the moving block is connected to the movable trunk assembly.

18. The trunk apparatus according to claim 17, wherein the lift actuator further comprises:
an upper support block fixed to a top end of the bed; and
a lower support block fixed to a bottom end of the bed, wherein a moving range of the moving block is restricted by the upper support block and the lower support block.

19. The trunk apparatus according to claim 16, further comprising:
a link mechanism configured to tiltably connect the tiltable rear spoiler to the movable trunk assembly; and
a tilt actuator configured to move the tiltable rear spoiler to be tiltable with respect to the movable trunk assembly, wherein the tilt actuator is mounted between the lift actuator and the tiltable rear spoiler.

20. A trunk apparatus, comprising:
a spoiler cover configured to be tiltable at a rear end of a vehicle;
a trunk assembly located below the spoiler cover and configured to move vertically at the rear end of the vehicle, wherein the trunk assembly is configured to move between a stowed position in which the trunk assembly is stowed in an interior space of the rear end of the vehicle and a deployed position in which the trunk assembly is deployed upward from the interior space of the rear end of the vehicle, wherein the trunk assembly comprises:
a trunk box having a storage opening that is open to a rear of the vehicle, and
a trunk cover attached to a top of the trunk box;
a lift actuator configured to move the trunk assembly upward and downward, wherein the lift actuator comprises:
a bed extending in a vertical direction of the vehicle,
a lead screw rotatably mounted on the bed,
a moving block movable in a longitudinal direction of the bed by the rotation of the lead screw,
a drive motor configured to rotate the lead screw, wherein the moving block is connected to the trunk assembly,
an upper support block fixed to a top end of the bed, and
a lower support block fixed to a bottom end of the bed, wherein a moving range of the moving block is restricted by the upper support block and the lower support block;
a link mechanism configured to tiltably connect the spoiler cover to the trunk assembly;
a tilt actuator configured to allow the spoiler cover to be tiltable with respect to the trunk assembly, wherein the tilt actuator is mounted between the lift actuator and the spoiler cover, wherein the tilt actuator includes a housing tube and a moving tube movably connected to the housing tube, wherein the housing tube includes a lower joint pivotally connected to the lift actuator, wherein the moving tube includes an upper joint pivotally connected to the spoiler cover, and wherein the upper joint is pivotally connected to the spoiler cover behind the link mechanism;
a latch mechanism configured to lock and unlock the spoiler cover to and from the rear end of the vehicle; and
a seal enclosing the trunk box, wherein the rear end of the vehicle has an opening through which the trunk box extends, and wherein the seal is mounted on edges of the opening.
